(19) United States
(12) Patent Application Publication
(10) Pub. No.: US 2006/0265697 A1
(43) Pub. Date: Nov. 23, 2006

(54) Pattern query language

(75) Inventors: Syed M. Ali, Menlo Park, CA (US); Yury Kamen, Menlo Park, CA (US); Deepak Alur, Fremont, CA (US); John P. Crupi, Bethesda, MD (US); Daniel B. Malks, Arlington, VA (US)

Correspondence Address: OSHA LIANG L.L.P./SUN, 1221 MCKINNEY, SUITE 2800, HOUSTON, TX, 77010, US

(73) Assignee: Sun Microsystems, Inc., Santa Clara, CA (US)

(21) Appl. No.: 11/133,660

(22) Filed: May 20, 2005

(51) Int. Cl. G06F 9/45

(52) U.S. Cl. 717/141

(57) ABSTRACT

A method for analyzing a target system, that includes obtaining a plurality of characteristics from the target system using a characteristics extractor, wherein the plurality of characteristics is defined in a characteristics model and each of the plurality of characteristics is associated with one of a plurality of artifacts defined in the characteristics model, storing each of the plurality of characteristics in a characteristics store, and analyzing the target system by issuing a query to the characteristics store to obtain an analysis result, wherein the query is used to determine the presence of a first pattern in the target system.

### CROSS-REFERENCE TO RELATED APPLICATIONS

The present application contains subject matter that may be related to the subject matter in the following U.S. applications filed on May 20, 2005, and assigned to the assignee of the present application: “Method and Apparatus for Tracking Changes in a System” (Attorney Docket No. 03226/631001; SUN050215); “Method and Apparatus for Transparent Invocation of a Characteristics Extractor for Pattern-Based System Design Analysis” (Attorney Docket No. 03226/633001; SUN050217); “Method and Apparatus for Generating Components for Pattern-Based System Design Analysis Using a Characteristics Model” (Attorney Docket No. 03226/634001; SUN050218); “Method and Apparatus for Pattern-Based System Design Analysis” (Attorney Docket No. 03226/635001; SUN050219); “Method and Apparatus for Cross-Domain Querying in Pattern-Based System Design Analysis” (Attorney Docket No. 03226/637001; SUN050222); “Method and Apparatus for Pattern-Based System Design Analysis Using a Meta Model” (Attorney Docket No. 03226/638001; SUN050223); and “Method and Apparatus for Generating a Characteristics Model for Pattern-Based System Design Analysis Using a Schema” (Attorney Docket No. 03226/642001; SUN050227).

### BACKGROUND

As software technology has evolved, new programming languages and increased programming language functionality has been provided. The resulting software developed using this evolving software technology has become more complex. The ability to manage the quality of software applications (including design quality and architecture quality) is becoming increasingly more difficult as a direct result of the increasingly complex software. In an effort to manage the quality of software applications, several software development tools and approaches are now available to aid software developers in managing software application quality. The following is a summary of some of the types of quality management tools currently available.

One common type of quality management tool is used to analyze the source code of the software application to identify errors (or potential errors) in the source code. This type of quality management tool typically includes functionality to parse the source code written in a specific programming language (e.g., Java™, C++, etc.) to determine whether the source code satisfies one or more coding rules (i.e., rules that define how source code in the particular language should be written). Some quality management tools of the aforementioned type have been augmented to also identify various coding constructs that may result in security or reliability issues. While the aforementioned type of quality management tools corrects coding errors, it does not provide the software developer with any functionality to verify the quality of the architecture of software application.

Other quality management tools of the aforementioned type have been augmented to verify that software patterns have been properly implemented. Specifically, some quality management tools of the aforementioned type have been augmented to allow the software developer to indicate, in the source code, the type of software pattern the developer is using. Then the quality management tool verifies, during compile time, that the software pattern was used/implemented correctly.

In another implementation of the aforementioned type of quality management tools, the source code of the software is parsed and the components (e.g., classes, interfaces, etc.) extracted from the parsing are subsequently combined in a relational graph (i.e., a graph linking all (or sub-sets) of the components). In a subsequent step, the software developer generates an architectural design, and then compares the architectural design to the relational graph to determine whether the software application conforms to the architectural pattern. While the aforementioned type of quality management tool enables the software developer to view the relationships present in the software application, it does not provide the software developer with any functionality to conduct independent analysis on the extracted components.

Another common type of quality management tool includes functionality to extract facts (i.e., relationships between components (classes, interfaces, etc.) in the software) and subsequently displays the extracted facts to the software developer. While the aforementioned type of quality management tool enables the software developer to view the relationships present in the software application, it does not provide the developer with any functionality to independently query the facts or any functionality to extract information other than facts from the software application.

Another common type of quality management tool includes functionality to extract and display various statistics (e.g., number of lines of code, new artifacts added, software packages present, etc.) of the software application to the software developer. While the aforementioned type of quality management tool enables the software developer to view the current state of the software application, it does not provide the developer with any functionality to verify the quality of the architecture of the software application.

### SUMMARY

In general, in one aspect, the invention relates to a method for analyzing a target system, comprising obtaining a plurality of characteristics from the target system using a characteristics extractor, wherein the plurality of characteristics is defined in a characteristics model and each of the plurality of characteristics is associated with one of a plurality of artifacts defined in the characteristics model, storing each of the plurality of characteristics in a characteristics store, and analyzing the target system by issuing a query to the characteristics store to obtain an analysis result, wherein the query is used to determine the presence of a first pattern in the target system.

In general, in one aspect, the invention relates to a system, comprising a characteristics model defining a plurality of artifacts and a plurality of characteristics wherein each of the plurality of characteristics is associated with one of the plurality of artifacts, a target system comprising at least one of the plurality of characteristics defined in the characteristics model, at least one characteristics extractor configured to obtain at least one of the plurality of characteristics from the target system, a characteristics store configured to store the at least one of the plurality of characteristics obtained from the target system, and a query engine configured to analyze the target system by issuing a query to the characteristics store and configured to obtain an analysis result in response to the a query, wherein the query is used to determine the presence of a first pattern in the target system.

In general, in one aspect, the invention relates to a computer readable medium comprising software instructions for analyzing a target system, comprising software instructions to obtain a plurality of characteristics from the target system using a characteristics extractor, wherein the plurality of characteristics is defined in a characteristics model and each of the plurality of characteristics is associated with one of the plurality of artifacts defined in the characteristics model, store each of the plurality of characteristics in a characteristics store, and analyze the target system by issuing a query to the characteristics store to obtain an analysis result, wherein the query is used to determine the presence of a first pattern in the target system.

Other aspects of the invention will be apparent from the following description and the appended claims.

### BRIEF DESCRIPTION OF DRAWINGS

FIG. 1 shows a system in accordance with one embodiment of the invention.

FIG. 2 shows a characteristics model in accordance one embodiment of the invention.

FIGS. 3 through 5 show flowcharts in accordance with one embodiment of the invention.

FIG. 6 shows an example in accordance with one embodiment of the invention.

FIG. 7 shows a computer system in accordance with one embodiment of the invention.

### DETAILED DESCRIPTION

Exemplary embodiments of the invention will be described with reference to the accompanying drawings. Like items in the drawings are shown with the same reference numbers.

In the exemplary embodiment of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

In general, embodiments of the invention relate to a method and apparatus for pattern-based system design analysis. More specifically, embodiments of the invention provide a method and apparatus for using one or more characteristics models, one or more characteristics extractors, and a query engine configured to query the characteristics of a target system to analyze the system design. Embodiments of the invention provide the software developer with a fully configurable architectural quality management tool that enables the software developer to extract information about the characteristics of the various artifacts in the target system, and then issue queries to determine specific details about the various artifacts including, but not limited to, information such as: number of artifacts of the specific type present in the target system, relationships between the various artifacts in the target system, the interaction of the various artifacts within the target system, the patterns that are used within the target system, etc.

Further, embodiments of the invention provide a method and apparatus for defining queries that are used to determine the presence of a pattern in the target system. More specifically, embodiments of the invention provide a pattern query language (PQL) that is used to define the aforementioned queries. In one embodiment of the invention, the PQL allows the user to define one or more simple queries, one or more compound queries that are used to determine relationships between results of two or more simple queries, and one or more nested queries that are used to determine the presence of a relationship between the results of two or more compound queries or the presence of a relationship between the result of at least one simple query and the result at least one compound query. In addition, the nested query may be used to determine the relationship between the results of two or more nested queries.

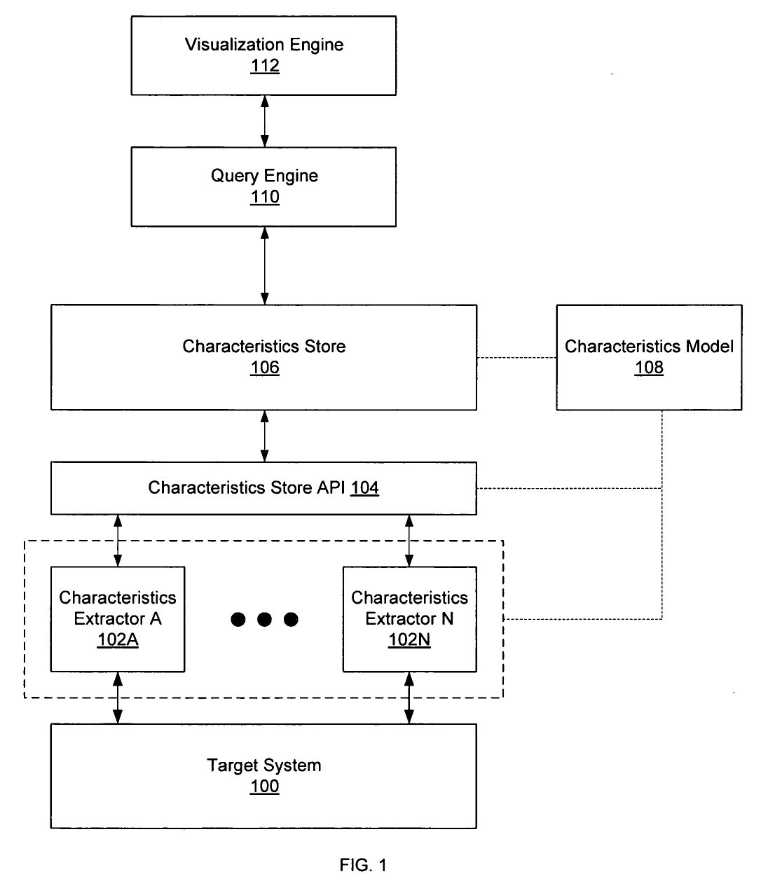

FIG. 1 shows a system in accordance with one embodiment of the invention. The system includes a target system (100) (i.e., the system that is to be analyzed) and a number of components used in the analysis of the target system. In one embodiment of the invention, the target system (100) may correspond to a system that includes software, hardware, or a combination of software and hardware. More specifically, embodiments of the invention enable a user to analyze specific portions of a system or the entire system. Further, embodiments of the invention enable a user to analyze the target system with respect to a specific domain (discussed below). Accordingly, the target system (100) may correspond to any system under analysis, where the system may correspond to the entire system including software and hardware, or only a portion of the system (e.g., only the hardware portion, only the software portion, a sub-set of the hardware or software portion, or any combination thereof). As shown in FIG. 1, the system includes the following components to aid in the analysis of the target system: one or more characteristics extractors (e.g., characteristics extractor A (102A), characteristics extractor N (102N)), a characteristics store application programming interface (API) (104), a characteristics store (106), a characteristics model (108), a query engine (110), and visualization engine (112). Each of these components is described below.

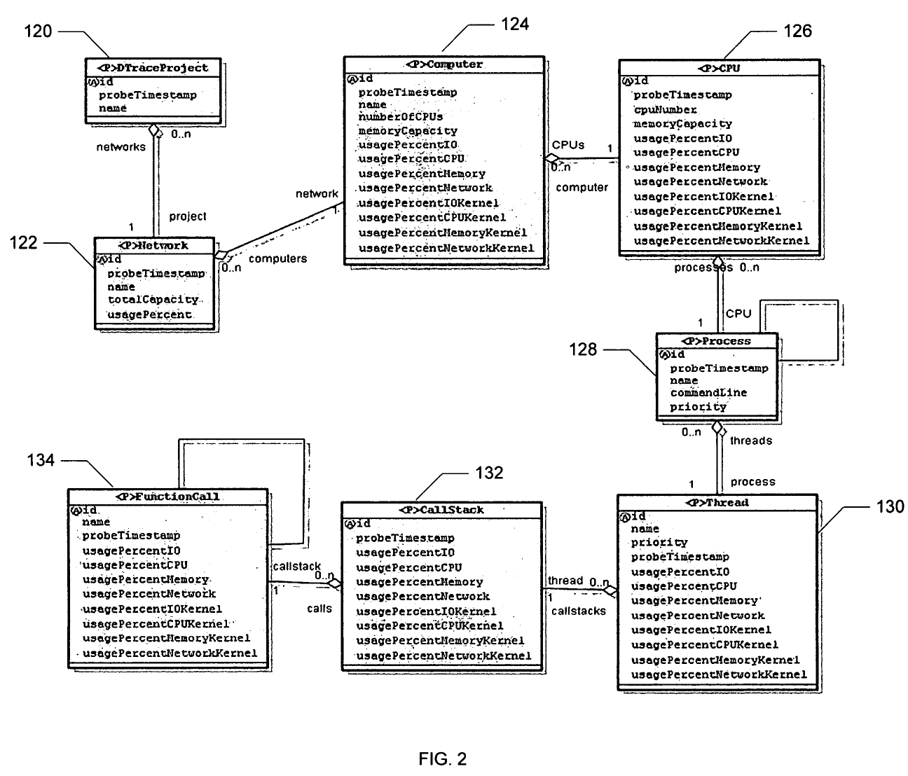

In one embodiment of the system, the characteristics model (108) describes artifacts (i.e., discrete components) in a particular domain. In one embodiment of the invention, the domain corresponds to any grouping of “related artifacts” (i.e., there is a relationship between the artifacts). Examples of domains include, but are not limited to, a Java™ 2 Enterprise Edition (J2EE) domain (which includes artifacts such as servlets, filters, welcome file, error page, etc.), a networking domain (which includes artifacts such as web server, domain name server, network interface cards, etc), and a DTrace domain (described below). In one embodiment of the invention, each characteristics model includes one or more artifacts, one or more relationships describing the interaction between the various artifacts, and one or more characteristics that describe various features of the artifact. An example of a characteristics model (108) is shown in FIG. 2. Those skilled in the art will appreciate that the system may include more than one characteristics model (108).

In one embodiment of the invention, the use of a characteristics model (108) enables a user to analyze the target system (100) with respect to a specific domain. Further, the use of multiple characteristics models allows the user to analyze the target system (100) across multiple domains. In addition, the use of multiple characteristics models allows the user to analyze the interaction between various domains on the target system (100).

In one embodiment of the invention, the characteristics extractors (e.g., characteristics extractor A (102A), characteristics extractor N (102N)) are used to obtain information about various artifacts (i.e., characteristics) defined in the characteristics model (108). In one embodiment of the invention, the characteristics extractors (characteristics extractor A (102A), characteristics extractor B (102N)) are generated manually using the characteristics model (108).

In one embodiment of the invention, the characteristics extractor (e.g., characteristics extractor A (102A), characteristics extractor B (102N)) corresponds to an agent loaded on the target system (100) that is configured to monitor and obtain information about the artifacts in the target system (100). Alternatively, the characteristics extractor (e.g., characteristics extractor A (102A), characteristics extractor B (102N)) may correspond to an interface that allows a user to manually input information about one or more artifacts in the target system (100). In another embodiment of the invention, the characteristics extractor (e.g., characteristics extractor A (102A), characteristics extractor B (102N)) may correspond to a process (or system) configured to obtain information about one or more artifacts in the target system (100) by monitoring network traffic received by and sent from the target system (100). In another embodiment of the invention, the characteristics extractor (e.g., characteristics extractor A (102A), characteristics extractor B (102N)) may correspond to a process (or system) configured to obtain information about one or more artifacts in the target system (100) by sending requests (e.g., pinging, etc.) for specific pieces of information about artifacts in the target system (100) to the target system (100), or alternatively, sending requests to the target system and then extracting information about the artifacts from the responses received from target system (100). Those skilled in the art will appreciate that different types of characteristics extractors may be used to obtain information about artifacts in the target system (100).

Those skilled in the art will appreciate that each characteristics extractor (or set of characteristics extractors) is associated with a particular characteristics model (108). Thus, each characteristics extractor typically only retrieves information about artifacts described in the characteristics model with which the characteristics extractor is associated. Furthermore, if there are multiple characteristics models in the system, then each characteristics model may be associated with one or more characteristics extractors.

The information about the various artifacts in the target system (100) obtained by the aforementioned characteristics extractors (e.g., characteristics extractor A (102A), characteristics extractor N (102N)) is stored in the characteristics store (106) via the characteristic store API (104). In one embodiment of the invention, characteristics store API (104) provides an interface between the various characteristics extractors (characteristics extractor A (102A), characteristics extractor N (102N)) and the characteristics store (106). Further, the characteristics store API (104) includes information about where in the characteristics store (106) each characteristic obtained from the target system (100) should be stored.

In one embodiment of the invention, the characteristics store (106) corresponds to any storage that includes functionality to store characteristics in a manner that allows the characteristics to be queried. In one embodiment of the invention, the characteristics store (106) may correspond to a persistent storage device (e.g., hard disk, etc). In one embodiment of the invention, the characteristics store (106) corresponds to a relational database that may be queried using a query language such as Structure Query Language (SQL). Those skilled in the art will appreciate that any query language may be used. In one embodiment of the invention, if the characteristics store (106) is a relational database, then the characteristics store (106) includes a schema associated with the characteristics model (108) that is used to store the characteristics associated with the particular characteristics model (108). Those skilled in the art will appreciate that, if there are multiple characteristics models, then each characteristics model (108) may be associated with a separate schema.

In one embodiment of the invention, if the characteristics store (106) is a relational database that includes a schema associated with the characteristics model (108), then the characteristics store API (104) includes the necessary information to place characteristics obtained from target system (100) in the appropriate location in the characteristics store (106) using the schema.

In one embodiment of the invention, the query engine (110) is configured to issue queries to the characteristics store (106). In one embodiment of the invention, the queries issued by the query engine (110) enable a user (e.g., a system developer, etc.) to analyze the target system (100). In particular, in one embodiment of the invention, the query engine (110) is configured to enable the user to analyze the presence of specific patterns in the target system as well as the interaction between various patterns in the target system.

In one embodiment of the invention, a pattern corresponds to a framework that defines how specific components in the target system (100) should be configured (e.g., what types of information each component should manage, what interfaces should each component expose), and how the specific components should communicate with each other (e.g., what data should be communicated to other components, etc.). Patterns are typically used to address a specific problem in a specific context (i.e., the software/system environment in which the problem arises). Said another way, patterns may correspond to a software architectural solution that incorporates best practices to solve a specific problem in a specific context. An example of pattern is a session facade pattern for Java™ 2 Enterprise Edition. Those skilled in the art will appreciate that patterns are not limited to software patterns.

In one embodiment of the invention, a pattern corresponds to a relationship between two or more artifacts. More specifically, the pattern corresponds to a relationship between two or more specific artifacts (i.e., artifacts with a specific characteristic or specific characteristics) in the target system. Those skilled in the art will appreciate that the artifacts within a given pattern do not need to belong to the same domain (i.e., defined by a specific characteristics model).

Continuing with the discussion of FIG. 1, the query engine (10) may also be configured to issue queries about interaction of specific patterns with components that do not belong to a specific pattern. Further, the query engine (110) may be configured to issue queries about the interaction of components that do not belong to any patterns.

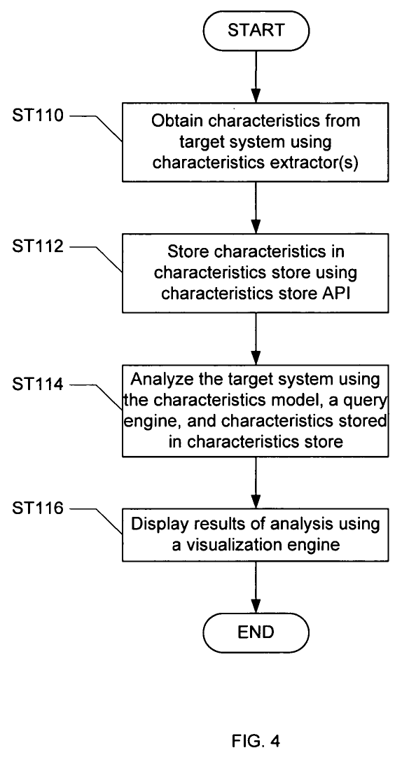

In one embodiment of the invention, the query engine (110) may include pre-specified queries and/or enable to the user to specify custom queries. In one embodiment of the invention, both the pre-specified queries and the custom queries are used to identify the presence of one or more patterns and/or the presence of components that do not belong to a pattern in the target system (100). In one embodiment of the invention, the pre-specified queries and the custom queries are specified using a Pattern Query Language (PQL). In one embodiment of the invention, PQL enables the user to query the artifacts and characteristics of the artifacts stored in the characteristics store (106) to determine the presence of a specific pattern, specific components of a specific pattern, and/or other components that are not part of a pattern, within the target system (100). The use of PQL is described below in FIGS. 4-6.

In one embodiment of the invention, the query engine (110) may include information (or have access to information) about the characteristics model (108) that includes the artifact and/or characteristics being queried. Said another way, if the query engine (110) is issuing a query about a specific artifact, then the query engine (110) includes information (or has access to information) about the characteristics model to which the artifact belongs. Those skilled in the art will appreciate that the query engine (110) only requires information about the particular characteristics model (108) to the extent the information is required to issue the query to the characteristics store (106).

Those skilled in the art will appreciate that the query engine (110) may include functionality to translate PQL queries (i.e., queries written in PQL) into queries written in a query language understood by the characteristics store (106) (e.g., SQL). Thus, a query written in PQL may be translated into an SQL query prior to being issued to the characteristics store (106). In this manner, the user only needs to understand the artifacts and/or characteristics that the user wishes to search for and how to express the particular search using PQL. The user does not need to be concerned with how the PQL query is handled by the characteristics store (106).

Further, in one or more embodiments of the invention, PQL queries may be embedded in a programming language such as Java™, Groovy, or any other programming language capable of embedding PQL queries. Thus, a user may embed one or more PQL queries into a program written in one of the aforementioned programming languages. Upon execution, the program issues one or more PQL queries embedded within the program and subsequently receives and processes the results prior to displaying them to the user. Those skilled in the art will appreciate that the processing of the results is performed using functionality of the programming language in which the PQL queries are embedded.

In one embodiment of the invention, the results of the individual PQL queries may be displayed using the visualization engine (112). In one embodiment of the invention, the visualization engine (112) is configured to output the results of the queries on a display device (i.e., monitor, printer, projector, etc.).

As discussed above, each characteristics model defines one or more artifacts, one or more relationships between the artifacts, and one or more characteristics for each artifact. The following is an example of a DTrace characteristics model. In the example, the DTrace characteristics model includes the following attributes: DTraceProject, Network, Computers, CPUs, Processes, Threads, Callstacks, and FunctionCalls. The DTrace characteristics model defines the following relationships between the aforementioned artifacts: DTraceProject includes one or more Networks, each Network includes one or more Computer, each Computer includes one or more CPUs, each CPU runs (includes) one or more Processes, each Process includes one or more Threads, each Thread includes one or more CallStacks, and each CallStacks includes one or more FunctionCalls.

The following characteristics are used in the DTrace characteristics model: id (i.e., unique CPU id), probeTimestamp (i.e., the performance probe timestamp), memoryCapacity (i.e., the memory available to artifact), cpuNumber (i.e., the number of this CPU in the Computer), usagePercentIO (i.e., the total 10 usage percent), usagePercentCPU (i.e., the total CPUusage percent), usagePercentMemory (i.e., the total memory usage percent), usagePercentNetwork (i.e., the total network bandwidth usage percent), usagePercentIOKernel (i.e., the kernel IO usage percent), UsagePercentCPUKernel (i.e., the kernel CPUusage percent), UsagePercentMemoryKernel (i.e., the kernel memory usage percent), and usagePercentNetworkKernel (i.e., the kernel network bandwidth usage percent).

The following is a DTrace characteristics model in accordance with one embodiment of the invention.

DTrace Characteristics Model

| | |
|---|---|
| 1 | persistent class DTraceProject { |
| 2 | Long id; |
| 3 | Timestamp probeTimestamp; |
| 4 | String name; |
| 5 | owns Network theNetworks(0,n) inverse theDTraceProject(1,1); |
| 6 | } // class DTraceProject |
| 7 | |
| 8 | persistent class Computer { |
| 9 | Long id; |
| 10 | Timestamp probeTimestamp; |
| 11 | String name; |
| 12 | Long numberOfCPUs; |
| 13 | Long memoryCapacity; |
| 14 | Float usagePercentIO; |
| 15 | Float usagePercentCPU; |
| 16 | Float usagePercentMemory; |
| 17 | Float usagePercentNetwork; |
| 18 | Float usagePercentIOKernel; |
| 19 | Float usagePercentCPUKernel; |
| 20 | Float usagePercentMemoryKernel; |
| 21 | Float usagePercentNetworkKernel; |
| 22 | owns CPU theCPUs(0,n) inverse theComputer(1,1); |
| 23 | } // class Computer |
| 24 | |
| 25 | persistent class CPU { |
| 26 | Long id; |
| 27 | Timestamp probeTimestamp; |
| 28 | Long cpuNumber; |
| 29 | Long memoryCapacity; |
| 30 | Float usagePercentIO; |
| 31 | Float usagePercentCPU; |
| 32 | Float usagePercentMemory; |
| 33 | Float usagePercentNetwork; |
| 34 | Float usagePercentIOKernel; |
| 35 | Float usagePercentCPUKernel; |
| 36 | Float usagePercentMemoryKernel; |
| 37 | Float usagePercentNetworkKernel; |
| 38 | owns Process theProcesss(0,n) inverse theCPU(1,1); |
| 39 | } // class CPU |
| 40 | |
| 41 | persistent class Network { |
| 42 | Long id; |
| 43 | Timestamp probeTimestamp; |
| 44 | String name; |
| 45 | Long totalCapacity; |
| 46 | Float usagePercent; |
| 47 | owns Computer theComputers(0,n) inverse theNetwork(1,1); |
| 48 | } // class Network |
| 49 | |
| 50 | persistent class Process { |
| 51 | Long id; |
| 52 | Timestamp probeTimestamp; |
| 53 | String name; |
| 54 | String commandLine; |
| 55 | Integer priority; |
| 56 | owns Thread theThreads(0,n) inverse theProcess(1,1); |
| 57 | references Process theProcesss(0,n) inverse theProcess(1,1); |
| 58 | } // class Process |
| 59 | |
| 60 | persistent class CallStack { |
| 61 | Long id; |
| 62 | Timestamp probeTimestamp; |
| 63 | Float usagePercentIO; |
| 64 | Float usagePercentCPU; |
| 65 | Float usagePercentMemory; |
| 66 | Float usagePercentNetwork; |
| 67 | Float usagePercentIOKernel; |
| 68 | Float usagePercentCPUKernel; |
| 69 | Float usagePercentMemoryKernel; |
| 70 | Float usagePercentNetworkKernel; |
| 71 | owns FunctionCall theFunctionCalls(0,n) inverse |
| | theCallStack(1,1); |
| 72 | } // class CallStack |
| 73 | |
| 74 | persistent class Thread { |
| 75 | Long id; |
| 76 | String name; |
| 77 | Timestamp probeTimestamp; |
| 78 | Long priority; |
| 79 | Float usagePercentIO; |
| 80 | Float usagePercentCPU; |
| 81 | Float usagePercentMemory; |
| 82 | Float usagePercentNetwork; |
| 83 | Float usagePercentIOKernel; |
| 84 | Float usagePercentCPUKernel; |
| 85 | Float usagePercentMemoryKernel; |
| 86 | Float usagePercentNetworkKernel; |
| 87 | owns CallStack theCallStacks(0,n) inverse theThread(1,1); |
| 88 | } // class Thread |
| 89 | |
| 90 | persistent class FunctionCall { |
| 91 | Long id; |
| 92 | String name; |
| 93 | Timestamp probeTimestamp; |
| 94 | Float usagePercentIO; |
| 95 | Float usagePercentCPU; |
| 96 | Float usagePercentMemory; |
| 97 | Float usagePercentNetwork; |
| 98 | Float usagePercentIOKernel; |
| 99 | Float usagePercentCPUKernel; |
| 100 | Float usagePercentMemoryKernel; |
| 101 | Float usagePercentNetworkKernel; |
| 102 | references FunctionCall theFunctionCalls(0,n) inverse |
| | theFunctionCall(1,1); |
| 103 | } // class FunctionCall |

In the above DTrace Characteristics Model, the DTraceProject artifact is defined in lines 1-6, the Network artifact defined in lines 41-48, the Computer artifact is defined in lines 8-23, the CPU artifact is defined in lines 25-39, the Processes artifact is defined in lines 50-58, the Thread artifact is defined in lines 74-88, the Callstacks artifact is defined in 61-72, and the FunctionCall artifacts is defined in lines 90-103.

A graphical representation of the aforementioned DTrace characteristics model is shown in FIG. 2. Specifically, the graphical representation of the DTrace characteristics model shows each of the aforementioned artifacts, characteristics associated with each of the aforementioned artifacts, and the relationships (including cardinality) among the artifacts. In particular, box (120) corresponds to the DTraceProject artifact, box (122) corresponds to the Network artifact, box (124) corresponds to the Computer artifact, box (126) corresponds to the CPU artifact, box (128) corresponds to the Process artifact, box (130) corresponds to the Thread artifact, box (132) corresponds to the CallBack artifact, and box (134) corresponds to the FunctionCall artifact.

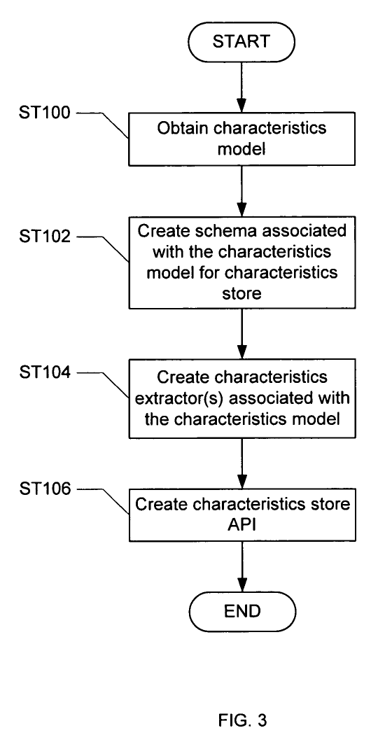

FIG. 3 shows a flowchart in accordance with one embodiment of the invention. Initially, a characteristics model is obtained (ST100). In one embodiment of the invention, the characteristics model is obtained from a pre-defined set of characteristics models. Alternatively, the characteristics model is customized characteristics model to analyze a specific domain in the target system and obtained from a source specified by the user.

Continuing with the discussion of FIG. 3, a schema for the characteristics store is subsequently created and associated with characteristics model (ST102). One or more characteristics extractors associated with characteristics model are subsequently created (ST104). Finally, a characteristics store API is created (ST106). In one embodiment of the invention, creating the characteristics store API includes creating a mapping between characteristics obtained by the characteristics extractors and tables defined by the schema configured to store the characteristics in the characteristics store.

Those skilled in the art will appreciate that ST100-ST106 may be repeated for each characteristics model. In addition, those skilled in the art will appreciate that once a characteristics store API is created, the characteristics store API may only need to be modified to support additional schemas in the characteristics data store and additional characteristics extractors. Alternatively, each characteristics model may be associated with a different characteristics store API.

At this stage, the system is ready to analyze a target system. FIG. 4 shows a flowchart in accordance with one embodiment of the invention. Initially, characteristics are obtained from the target system using one or more characteristics extractors (ST110). In one embodiment of the invention, the characteristics extractors associated with a given characteristics model only obtain information about characteristics associated with the artifacts defined in the characteristics model.

Continuing with the discussion of FIG. 4, the characteristics obtained from the target system using the characteristics extractors are stored in the characteristics store using the characteristics store API (ST112). Once the characteristics are stored in the characteristics store, the target system may be analyzed using the characteristics model (or models), a query engine, and the characteristics stored in the characteristics store (ST114). In one embodiment of the invention, the user uses the query engine to issue queries to characteristics store. As discussed above, the query engine may include information (or have access to information) about the characteristics models currently being used to analyze the target system. The results of the analysis are subsequently displayed using a visualization engine (ST116).

Those skilled in the art will appreciate that ST110-ST112 may be performed concurrently with ST114-ST116. In addition, steps in FIG. 3, may be performed concurrently with the steps in FIG. 4.

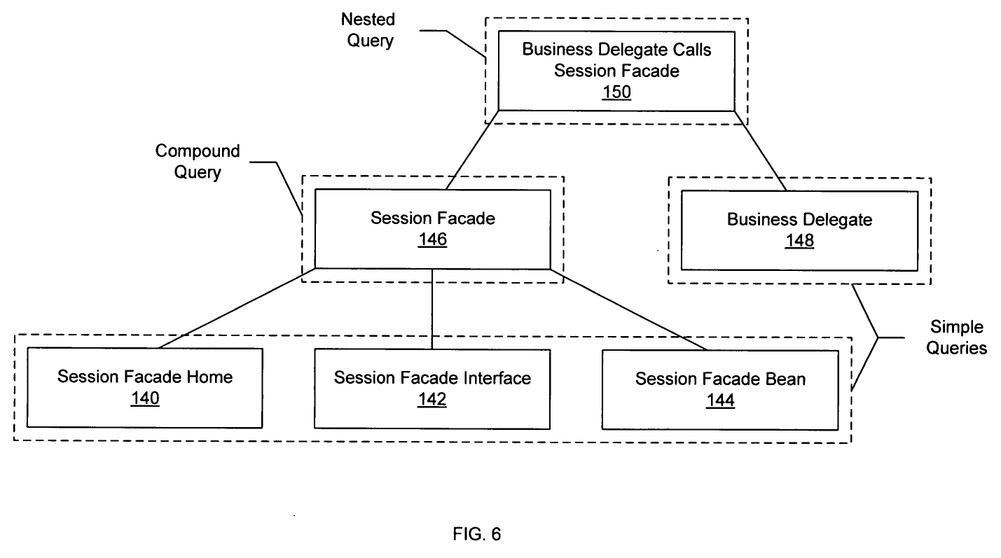

As discussed above, the queries used to analyze the target system may be written in PQL. In one embodiment of the invention, PQL defines queries that are used to determine the presence of a pattern(s) in the target system. As discussed above, a pattern may correspond to a relationship between two or more artifacts. More specifically, the pattern may correspond to a relationship between two or more specific artifacts (i.e., artifacts with a specific characteristic or specific characteristics) in the target system. The particular number of artifacts and relationships between artifacts in the pattern varies with the complexity of the pattern. A simple pattern may only include two artifacts having a single relationship (i.e., artifact A calls artifact B). However, a more complex pattern may include multiple artifacts and many different relationships. An example of a complex pattern is shown in FIG. 6. In one embodiment of the invention, a PQL query (i.e., a query defined using PQL) is created using simple queries, compound queries, and nested queries. Each of the aforementioned query types are discussed below.

In one embodiment of the invention, a simple query corresponds to a PQL query that is used to determine the presence of a particular artifact (i.e., an artifact having a particular characteristic(s)) in the characteristics store. Simple queries typically return a result that includes the list of artifacts that include the particular characteristic(s). In one embodiment of the invention, compound queries correspond to queries that are used to determine the presence of a relationship between the results of two or more simple queries. Thus, the compound queries filter the results of one or more simple queries by searching for relationships between the results of the two or more simple queries. Accordingly, only results (i.e., the results of the simple queries) that satisfy the relationships (e.g., creates, calls, implements, etc.) defined in the compound query are part of the result set of compound query.

In one embodiment of the invention, nested queries correspond to queries that are used to: (i) determine the presence of a relationship between the results of two or more compound queries; (ii) determine the presence of a relationship between the result of at least one simple query and at least one compound query;

(iii) determine the presence of a relationship between the results of two or more nested queries; and (iv) determine the presence of a relationship between the result of at least one nested query and the result of at least one simple query. The nested queries operate to filter the aforementioned results in the same manner as the compound queries. Examples of simple, compound, and nested queries are shown in FIG. 6.

In one embodiment of the invention, each of the simple queries may be used within one or more compound query and/or one or more nested queries. Said another way, the results of a simple query may be used by one or more compound queries or one or more nested queries. Thus, conceptually the simple queries provide a pattern component vocabulary that may be used to create compound and nested queries, where the compound and nested queries are used to determine the presence of particular patterns in the target system. In one embodiment of the invention, a pattern may be defined using a compound query (i.e., a compound query may be used to determine the presence of pattern). Further, in one embodiment of the invention, a pattern may be defined using a nested query (i.e., a nested query may be used to determine the presence of pattern). Those skilled in the art will appreciate that the results of a compound query that defines a pattern may be used in a nested query to determine the presence of a pattern that includes the pattern defined by the compound query.

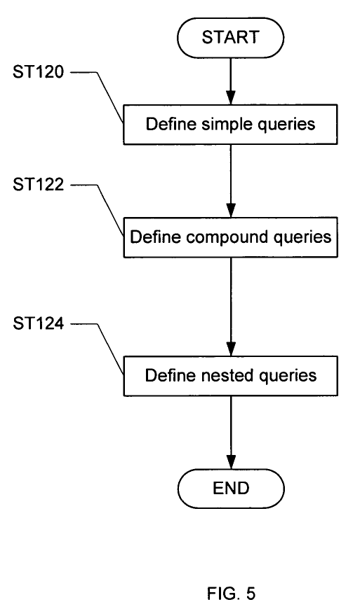

FIG. 5 shows a flowchart in accordance with one embodiment of the invention. More specifically, FIG. 5 shows a method for defining a PQL query to determine the presence of pattern in a target system in accordance with one embodiment of the invention. Initially, one or more simple queries required to determine the presence of the pattern are defined (ST120). Once the simple queries have been defined, compound queries and nested queries may be defined that use the results of one or more simple queries. One or more compound queries are subsequently defined (ST122). As discussed above, the compound queries are used to define relationships between the results of two or more simple queries.

Depending on the specific pattern that is the target of the PQL query, the PQL query may only need to be a compound query (i.e., the compound query can be used to determine the presence of the pattern). However, if the pattern is more complex (i.e., the presence of the pattern can only be determined using a nested query), then one or more nested queries (as required to find the target pattern) are created (ST124). At this stage, the appropriate simple, compound and/or nested queries have been defined to determine the presence of the target pattern. In one embodiment of the invention, the simple queries, the compound queries, the nested queries, or any combination thereof are pre-defined.

The following is an example of a PQL query that is used to determine the presence of the pattern: Business Delegate calling Session Facade. The example is only intended to illustrate an embodiment of the invention and is not intended to limit the invention.

FIG. 6 shows an example in accordance with one embodiment of the invention. More specifically, FIG. 6 shows the various PQL queries that are required to determine the presence of the pattern: Business Delegate calling Session Facade. As shown in FIG. 6, there are four simple queries: a session facade home query (140), a session facade interface query (142), a session facade bean query (144), and a business delegate query (148). The source code for each of the aforementioned PQL queries is included below.

Session Facade Home Query

define SFHomes as
select c
from classes c
where c.extendsClass.**.name in (“javax.ejb.EJBHome”,
“javax.ejb.EJBLocalHome”)

Session Facade Interface Query

DEFINE SFInterfaces1 AS SELECT c FROM classes c
WHERE c.extendsClass.**.name IN
(“javax.ejb.EJBLocalObject”,“javax.ejb.EJBObject”);
DEFINE SFInterfaces2 AS SELECT c FROM classes c
WHERE c.implementsInterfaces.**.name IN
(“javax.ejb.EJBLocalObject”,“javax.ejb.EJBObject”);
DEFINE SFInterfaces AS SFInterfaces1 + SFInterfaces2

Session Facade Bean

Define SFBeans as
select c
from classes c
where c.extendsClass.**.name in (“javax.ejb.SessionBean”) OR
c.implementsInterfaces.**.name in (“javax.ejb.SessionBean”)

Business Delegate

define EJBServiceLocators as
select c from classes c
where c.methods.calls.parentClass.name=“javax.naming.InitialContext”
and c.methods.returnType.name in (“javax.ejb.EJBObject”,
“javax.ejb.EJBHome”,
“javax.ejb.EJBLocalHome”);
define classesCallingServiceLocators as
select c from classes c
where c.methods.calls.**.parentClass in EJBServiceLocators;
define BusinessDelegates as
select c from classesCallingServiceLocators c
where c.fields.type in SFInterfaces;

As shown in FIG. 6, a session facade query (146), which is a compound query, is used to determine the presence of a relationship between the results of the session facade home query (140), the session facade interface query (142), and the session facade bean query (144). The session facade query (146) is used to identify the session facades in the target system. The relationships session facade query (146) identifies the presences of a “creates” relationship between the results of the session facade home query (140) and the results of the session facade interface query (142) and the presence of an “implements” relationship between the results of the session facade bean query (144) and the results of the session facade interface query (142). Thus, the results in the three aforementioned queries (i.e., 140, 142, and 144) that satisfy both the aforementioned relationships corresponds to results that are session facades. The source code for the session facade query (146) is included below.

Session Facade Query

define SessionFacades as
select sfi as Interface, sfi.implementingClasses as Bean,
sfi.methods.callers.parentClass
as Home
from SFInterfaces sfi
where sfi.methods.callers.parentClass in SFHomes;

Finally, as shown in FIG. 6, a business delegate calls session facade query (150), which is a nested query, is used to determine the presence of a relationship between the results of the session facade query (146) and the business delegate query (148). Specifically, the business delegate calls session facade query (150) is used to determine which business delegates (identified using the business delegate query (148)) call a session facade (identified using the session facade query (146) and the underlying simple queries (140, 142, 144)). The source code for the business delegate calls session facade query (150) is shown below.

Business Delegate Calling Session Facade

define BD_Calling_SF as
select bd, bd.fields.type from BusinessDelegates bd
where bd.fields.type in SessionFacades.Interface;

Those skilled in the art will appreciate that while the PQL is used to define the simple, compound, and nested queries to determine the presence of a pattern, that the characteristics store may not be configured to execute PQL queries. In such scenarios, the PQL queries are converted into a query language understood by the characteristics store prior to be issued to the characteristics store.

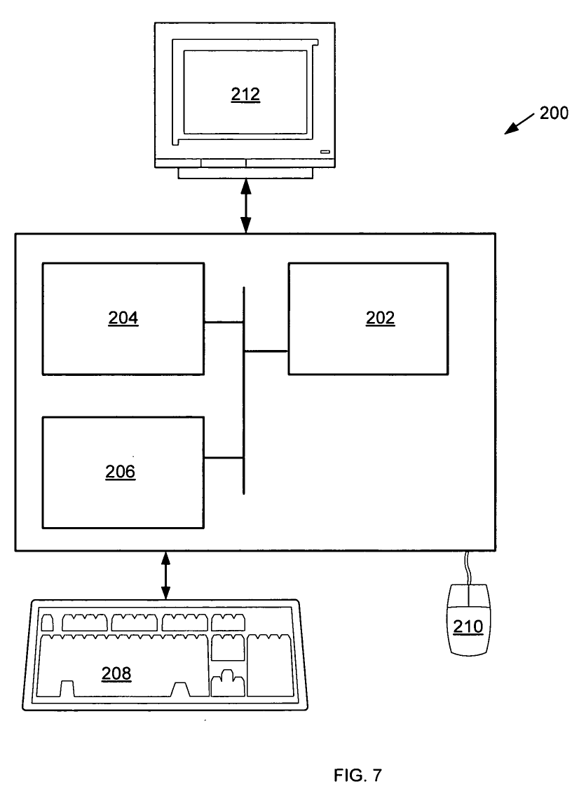

An embodiment of the invention may be implemented on virtually any type of computer regardless of the platform being used. For example, as shown in FIG. 7, a networked computer system (200) includes a processor (202), associated memory (204), a storage device (206), and numerous other elements and functionalities typical of today's computers (not shown). The networked computer (200) may also include input means, such as a keyboard (208) and a mouse (210), and output means, such as a monitor (212). The networked computer system (200) is connected to a local area network (LAN) or a wide area network via a network interface connection (not shown). Those skilled in the art will appreciate that these input and output means may take other forms. Further, those skilled in the art will appreciate that one or more elements of the aforementioned computer (200) may be located at a remote location and connected to the other elements over a network. Further, software instructions to perform embodiments of the invention may be stored on a computer readable medium such as a compact disc (CD), a diskette, a tape, a file, or any other computer readable storage device.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for analyzing a target system, comprising:
obtaining a plurality of characteristics from the target system using a characteristics extractor, wherein the plurality of characteristics is defined in a characteristics model and each of the plurality of characteristics is associated with one of a plurality of artifacts defined in the characteristics model;
storing each of the plurality of characteristics in a characteristics store; and
analyzing the target system by issuing a query to the characteristics store to obtain an analysis result, wherein the query is used to determine the presence of a first pattern in the target system.

2. The method of claim 1, further comprising:
obtaining the characteristics model;
generating the characteristics extractor associated with the characteristics model; and
generating a characteristics store application programming interface (API) associated with the characteristics model, wherein the characteristics extractor uses the characteristics store to store each of the plurality of characteristics in the characteristics store.

3. The method of claim 1, wherein the query comprises a plurality of simple queries and a compound query, wherein the compound query is used to determine the presence of a relationship between results of at least two of the plurality of simple queries.

4. The method of claim 3, wherein each of the plurality of simple queries are used to determine the presence of an artifact with a specific characteristic in the characteristics store.

5. The method of claim 1, wherein the query comprises a plurality of simple queries, a plurality of compound queries and at least one nested query, wherein each of the plurality of compound queries is used to determine the presence of a relationship between results of at least two of the plurality of simple queries, and wherein the at least one nested query is used to determine the presence of a relationship between results of at least two of the plurality of compound queries.

6. The method of claim 1, wherein the query comprises a plurality of simple queries, a plurality of compound queries and at least one nested query, wherein each of the plurality of compound queries is used to determine the presence of a relationship between results of at least two of the plurality of simple queries, and wherein the nested query is used to determine the presence of a relationship between a result of at least one of the plurality of compound queries and a result of at least one of the plurality of simple queries.

7. The method of claim 1, wherein the query is defined using a pattern query language.

8. The method of claim 7, wherein the pattern query language uses a plurality of simple queries and a compound query to define the query.

9. The method of claim 8, wherein the compound query is used to determine the presence of a second pattern in the characteristics store, wherein the second pattern is part of the first pattern.

10. The method of claim 7, wherein the pattern query language uses a plurality of simple queries, a plurality of compound queries, and a nested query to define the query.

11. The method of claim 10, wherein the nested query is used to determine the presence of a third pattern in the characteristics store and wherein the third pattern is part of the first pattern.

12. The method of claim 10, wherein results from each of the plurality of simple queries may be used in at least one selected from the group consisting of any one of the plurality of compound queries and the nested query.

13. A system, comprising:
a characteristics model defining a plurality of artifacts and a plurality of characteristics wherein each of the plurality of characteristics is associated with one of the plurality of artifacts;
a target system comprising at least one of the plurality of characteristics defined in the characteristics model;
at least one characteristics extractor configured to obtain at least one of the plurality of characteristics from the target system;
a characteristics store configured to store the at least one of the plurality of characteristics obtained from the target system; and
a query engine configured to analyze the target system by issuing a query to the characteristics store and configured to obtain an analysis result in response to the a query, wherein the query is used to determine the presence of a first pattern in the target system.

14. The method of claim 13, further comprising:
a characteristics store API, wherein the at least one characteristics extractor is configured to use the characteristics store API to store at least one of the plurality of characteristics obtained from the target system in the characteristics store.

15. The system of claim 13, wherein the query comprises a plurality of simple queries and a compound query, wherein the compound query is used to determine the presence of a relationship between results of at least two of the plurality of simple queries.

16. The system of claim 15, wherein each of the plurality of simple queries are used to determine the presence of an artifact with a specific characteristic in the characteristics store.

17. The system of claim 13, wherein the query comprises a plurality of simple queries, a plurality of compound queries and at least one nested query, wherein each of the plurality of compound queries is used to determine the presence of a relationship between results of at least two of the plurality of simple queries, and wherein the nested query is used to determine the presence of a relationship between results of at least two of the plurality of compound queries.

18. The system of claim 13, wherein the query comprises a plurality of simple queries, a plurality of compound queries and at least one nested query, wherein each of the plurality of compound queries is used to determine the presence of a relationship between results of at least two of the plurality of simple queries, and wherein the nested query is used to determine the presence of a relationship between a result of at least one of the plurality of compound queries and a result of at least one of the plurality of simple queries.

19. The system of claim 13, wherein the query is defined using a pattern query language.

20. The system of claim 19, wherein the pattern query language uses a plurality of simple queries and a compound query to define the query.

21. The system of claim 20, wherein the compound query is used to determine the presence of a second pattern in the characteristics store and wherein the second pattern is part of the first pattern.

22. The system of claim 13, wherein the pattern query language uses a plurality of simple queries, a plurality of compound queries, and a nested query to define the query.

23. The method of claim 22, wherein the nested query is used to determine the presence of a third pattern in the characteristics store, wherein the third pattern is part of the first pattern.

24. The method of claim 22, wherein results from each of the plurality of simple queries may be used in at least one selected from the group consisting of any one of the plurality of compound queries and the nested query.

25. A computer readable medium comprising software instructions for analyzing a target system, comprising software instructions to:
obtain a plurality of characteristics from the target system using a characteristics extractor, wherein the plurality of characteristics is defined in a characteristics model and each of the plurality of characteristics is associated with one of the plurality of artifacts defined in the characteristics model;
store each of the plurality of characteristics in a characteristics store; and
analyze the target system by issuing a query to the characteristics store to obtain an analysis result, wherein the query is used to determine the presence of a first pattern in the target system.

26. The computer readable medium of claim 25, wherein the query comprises a plurality of simple queries and a compound query and wherein the compound query is used to determine the presence of a relationship between results of at least two of the plurality of simple queries.

27. The computer readable medium of claim 26, wherein each of the plurality of simple queries are used to determine the presence of an artifact with a specific characteristic in the characteristics store.

28. The computer readable medium of claim 25, wherein the query comprises a plurality of simple queries, a plurality of compound queries and at least one nested query, wherein each of the plurality of compound queries is used to determine the presence of a relationship between results of at least two of the plurality of simple queries, and wherein the nested query is used to determine the presence of a relationship between results of at least two of the plurality of compound queries.

29. The computer readable medium of claim 25, wherein the query comprises a plurality of simple queries, a plurality of compound queries and at least one nested query, wherein each of the plurality of compound queries is used to determine the presence of a relationship between results of at least two of the plurality of simple queries, and wherein the nested query is used to determine the presence of a relationship between a result of at least one of the plurality of compound queries and a result of at least one of the plurality of simple queries.
